(19) United States
(12) Patent Application Publication
(10) Pub. No.: US 2023/0257926 A1
(43) Pub. Date: Aug. 17, 2023

(54) CLOTHING PROCESSING DEVICE

(71) Applicant: LG Electronics Inc., Seoul (KR)

(72) Inventors: Hyojin CHOI, Seoul (KR); Taewoong KONG, Seoul (KR); Chaseung JUN, Seoul (KR); Sangwook HONG, Seoul (KR)

(21) Appl. No.: 18/004,781

(22) PCT Filed: Jul. 8, 2021
(86) PCT No.: PCT/KR2021/008726

§ 371 Date: Jan. 9, 2023

(30) Foreign Application Priority Data
Jul. 10, 2020 (KR) 10-2020-0085158

(51) Int. Cl. D06F 58/26; D06F 25/00; D06F 39/04; D06F 37/04; D06F 37/26; D06F 58/04; H05B 6/36; H05B 6/10; H05B 6/40

(52) U.S. Cl. CPC D06F 58/26; D06F 25/00; D06F 39/04; D06F 37/04; D06F 37/267; D06F 58/04; H05B 6/365; H05B 6/105; H05B 6/40

(57) ABSTRACT

A clothing processing device disclosed in the present specification includes: a cabinet; a drum provided inside the cabinet, made of a metal material, and provided to receive a laundry therein; and an induction module which is spaced apart from the circumferential surface of the drum and heats the circumferential surface of the drum through a magnetic field generated when a current is applied to a coil having a wound wire, wherein: the induction module includes a base housing for receiving the coil; the coil includes a first region which is a portion located adjacent to the front of the drum, a third region which is a portion located adjacent to the rear of the drum, and a second region which is a portion positioned between the first region and the third region; and a shortest width of the first region or the third region is formed to be greater than a shortest width of the second region so that the coil having the wire wound on the base housing has different widths.

### TECHNICAL FIELD

The present disclosure relates to a laundry treating apparatus.

### BACKGROUND

In general, laundry treating apparatuses include various types of laundry treating apparatus, such as a washing machine for washing laundry, a dryer for drying the laundry, and a refresher for refreshing the laundry.

In the laundry treating apparatus, the washing refers to a process of putting water and detergent into the apparatus and removing contaminants from the laundry using a mechanical action, and the drying refers to a process of removing moisture contained in wet laundry.

In the washing process, washing with high-temperature washing water may dissolve more detergent, so that the contaminants on the laundry may be more easily removed, and at the same time, the laundry may be sterilized. Therefore, it is preferable to wash the laundry by increasing a temperature of the washing water within a range in which the laundry put into the laundry treating apparatus is not permanently deformed (e.g., shrinkage, distortion, loss of a waterproof function, and the like).

Conventionally, in order to increase the temperature of the washing water that comes into contact with the laundry, it has been common to receive hot water from the outside of the laundry treating apparatus or to supply the hot water to a tub by bringing the washing water into contact with a heating wire installed inside the laundry treating apparatus.

The scheme of receiving the hot water from the outside causes a problem of wasting energy because an external boiler must be operated separately. In addition, the scheme using the heating wire installed inside the laundry treating apparatus requires that the heating wire be continuously immersed in the washing water, so that there is a structural limitation that a separate flow channel must be defined below the tub.

In one example, in the drying process, conventionally, it is common to use a hot air drying scheme in which the laundry is dried by heating air circulating between the tub and an external circulation flow channel. A scheme of heating the air by placing the heating wire on the flow channel where the air circulates has been used.

In order to use the above-mentioned hot air drying scheme, a gas heater or an electric heater capable of heating the heating wire is required. However, the gas heater has problems of safety and exhaust gas, and the electric heater has problems in that foreign substances such as scale may accumulate and excessive energy is consumed.

In addition, there is a low-temperature dehumidifying drying scheme using a heat pump in addition to the above-described hot air drying scheme. The heat pump uses a cooling cycle of an air conditioner in reverse, so that the heat pump requires components such as an evaporator, a condenser, an expansion valve, and a compressor. Unlike the air conditioner that uses the condenser in an indoor unit to lower a temperature of indoor air, in a heat pump dryer, the evaporator heats the air to dry the laundry. However, compared to other hot air supply structures, the heat pump is bulky and has a complicated structure, and has a high production cost.

Furthermore, because the above hot airdrying scheme and low-temperature dehumidifying drying scheme are indirect drying schemes using the air, there is a disadvantage that a drying time may be long when the laundry is lumped or contains a lot of moisture.

In such various laundry treating apparatuses, each of the electric heater, the gas heater, and the heat pump as heating means has advantages and disadvantages. Concepts (Japanese Patent JP2001070689 and Korean Patent KR10-922986) for a laundry treating apparatus using induction heating as new heating means that may further strengthen the advantages and make up for compensate for the disadvantages of such components have been provided.

However, such prior arts only disclose basic concepts of performing the induction heating in the washing machine, and do not present specific induction heating module components, connection and operational relationships with basic components of the laundry treating apparatus, and specific methods or components for improving efficiency and securing safety.

Korean Patent Publication Application No. 10-2019-0016926 specifically discloses a component for performing the induction heating, but does not present a method for improving the efficiency.

Therefore, it is necessary to provide various and specific technical ideas for improving the efficiency and securing the safety in the laundry treating apparatus to which the induction heating principle is applied.

### SUMMARY

### Technical Problem

A purpose of the present disclosure is to provide a laundry treating apparatus that may directly heat a drum to heat washing water or dry laundry.

Another purpose of the present disclosure is to provide a laundry treating apparatus that may shorten a drying time of laundry by directly heating a drum.

Another purpose of the present disclosure is to provide a laundry treating apparatus that increases a drying efficiency by uniformly heating a central portion and front and rear portions of a drum.

### Technical Solutions

Various embodiments to solve the problems of the present disclosure are to provide an ‘H’-shaped coil structure in which, when an axis horizontal to a rotational direction of a drum is defined as a Y-axis and an axis perpendicular to the rotational direction is defined as the X-axis, a coil is wound wider at an outer portion than a center of the X-axis of the coil.

As the coil structure of the present embodiment is applied, more magnetic fields are linked to the drum in the outer portion of the X-axis, resulting in more heating of the drum. As a result, during operation of the laundry treating apparatus, temperature superposition occurs at the center of the X-axis, which was heated less, by the rotation of the drum to establish equilibrium between the temperatures at the center and the outer portion of the X-axis, so that a laundry treating apparatus in which front and rear portions of the drum may be uniformly heated may be provided.

In one example, various embodiments of the present disclosure are to provide a laundry treating apparatus including a cabinet, a drum disposed inside the cabinet and made of a metal material so as to accommodate laundry therein, and an induction module spaced apart from a circumferential surface of the drum and heating the circumferential surface of the drum via a magnetic field generated as a current is applied to a coil composed of a wound wire, wherein the induction module includes a base housing for accommodating the coil thereon, wherein the coil includes a first area positioned adjacent to a front portion of the drum, a third area positioned adjacent to a rear portion of the drum, and a second area positioned between the first area and the third area, and wherein a width of the first area or the third area is different from a width of the second area, and the wire is wound on the base housing such that the coil has different widths in the first area or the third area and the second area.

In addition, the laundry treating apparatus may further include a tub for accommodating the drum therein, the base housing may be fixed to the tub, and front and rear ends of the base housing may be spaced apart from front and rear ends of the tub by a predetermined distance, respectively.

The induction module may further include a cover housing coupled to the base housing from above and having a through portion defined therein for dissipating heat generated from the coil, and the induction module may further include a permanent magnet located on the coil and concentrating the magnetic field generated by the coil in a direction toward the drum. In addition, the permanent magnet may be disposed perpendicular to a longitudinal direction of the coil.

In addition, the permanent magnet may include a plurality of permanent magnets arranged to be spaced apart from each other along a longitudinal direction of the coil, and the number of permanent magnets arranged in the first area or the third area may be equal to or greater than the number of permanent magnets arranged in the second area.

The induction module may further include a permanent magnet housing disposed between the base housing and the cover housing and having mounting portions for respectively accommodating the permanent magnets therein.

The wire may be wound on the base housing such that the coil has straight portions and curved portions, and a radius of curvature of a portion of the wire forming the curved portion may be uniform in a coil inner portion and a coil outer portion.

The base housing may be formed by being curved in a shape corresponding to a shape of an outer circumferential surface of the drum, and the coil may be wound along the curvature of the base housing.

The base housing may further include a coil slot narrower than a diameter of the wire such that the wire is forcibly fitted thereinto.

A coil area formed as the wire is wound in the first area or the third area may be greater than a coil area formed as the wire is wound in the second area.

A vertical length of the base housing corresponding to a longitudinal direction of the drum is greater than a horizontal length of the base housing corresponding to a width direction of the drum.

The characteristics of the embodiments described above may be implemented in a composite manner in other embodiments as long as they are not contradictory or exclusive to the other embodiments.

### Advantageous Effects

According to various embodiments of the present disclosure, the heating time of the washing water and the drying time of the laundry may be shortened by directly heating the drum.

According to various embodiments of the present disclosure, as the IH module structure that may increase the amount of magnetic flux linkage in the portion heated less by the rotation of the drum is applied, the front and rear portions of the drum are uniformly heated to prevent the damage to the laundry and increase the washing and drying efficiency.

The effects of the present disclosure are not limited to those described above, and other effects not mentioned will be clearly recognized by those skilled in the art from the description below.

### BRIEF DESCRIPTION OF THE DRAWINGS

FIG. 1 is a view showing an overall configuration of a washing machine according to the present disclosure.

FIG. 2 shows a front view and a side view of an induction module and a drum.

FIG. 3 is a top view showing an arrangement structure of a coil and permanent magnets.

FIG. 4 is an exploded perspective view of an induction module.

FIG. 5 shows a top view and a bottom view of a base housing.

FIG. 6 is a top view showing an arrangement structure of a coil and permanent magnets according to one embodiment of the present disclosure.

FIG. 7 is a top view showing arrangement structures of a coil and permanent magnets according to various embodiments of the present disclosure.

FIG. 8 is a view showing a temperature distribution rate based on a coil shape.

### DETAILED DESCRIPTION

Hereinafter, a specific embodiment of the present disclosure will be described with reference to the drawings. Following detailed description is provided to provide a comprehensive understanding of a method, an apparatus, and/or a system described herein. However, this is merely an example and the present disclosure is not limited thereto.

In describing embodiments of the present disclosure, when it is determined that a detailed description of a known technology related to the present disclosure may unnecessarily obscure the gist of the present disclosure, the detailed description will be omitted. In addition, terms to be described later, as terms defined in consideration of functions thereof in the present disclosure, may vary based on intentions of users and operators or customs. Therefore, the definition thereof should be made based on the content throughout this specification. Terms used in the detailed description are for illustrating the embodiments of the present disclosure only, and should not be restrictive. Unless explicitly used otherwise, the singular expression includes the plural expression. Herein, expressions such as “comprising” or “including” are intended to indicate certain features, numbers, steps, operations, elements, and some or combinations thereof, and should not be construed to exclude a presence or a possibility of one or more other features, numbers, steps, operations, elements, or some or combinations thereof other than those described.

In addition, in describing components of an embodiment of the present disclosure, terms such as first, second, A, B, (a), (b), and the like may be used. These terms are only for distinguishing the components from other components, and an essence, an order, or a sequence of the corresponding components are not limited by the terms.

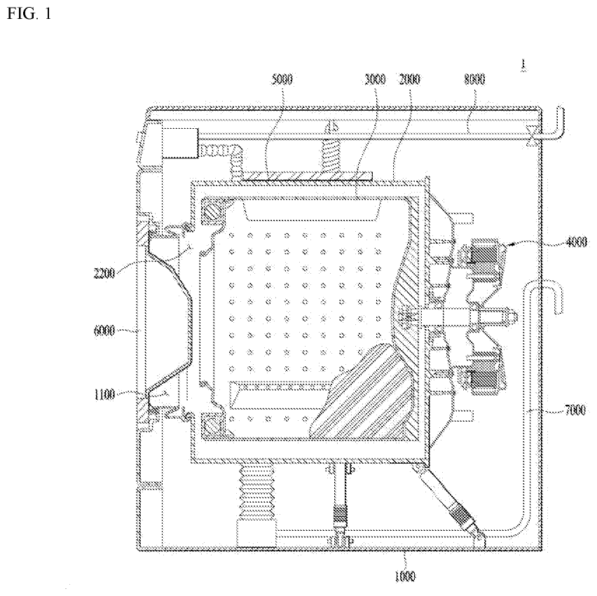

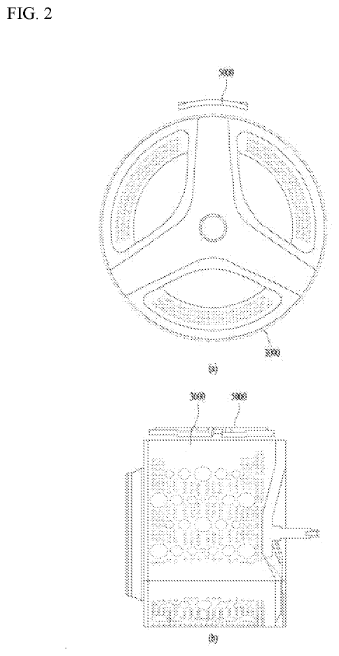

FIG. 1 is a view showing an overall configuration of a washing machine according to the present disclosure, and FIG. 2 shows a front view and a side view of an induction module and a drum.

An overall configuration of the present embodiment will be described with reference to FIGS. 1 and 2 below.

A laundry treating apparatus 1 of the present embodiment may include a cabinet 1000 that forms an outer appearance of the laundry treating apparatus 1 and has a laundry inlet 1100 through which laundry may be put into the apparatus, a tub 2000 located inside the cabinet 1000 and having an opening 2200 in communication with the laundry inlet 1100, a drum 3000 disposed inside the tub 2000 and made of a metal material so as to accommodate the laundry therein, a door 6000 coupled to the cabinet 1000 in a hinged manner so as to allow the laundry to be put into and be withdrawn from the apparatus, and an induction module 5000 for heating the drum 3000 using a magnetic field.

As shown in FIG. 1, the tub 2000 may be positioned inside the cabinet 1000 by means of a spring disposed on an inner side of a top surface of the cabinet 1000 and a damper 1200 disposed on a bottom surface of the cabinet 1000.

In addition, the tub 2000 may be fixed to an inner side of the bottom surface of the cabinet 1000 by a rear support (not shown) that is disposed at the rear of the tub 2000 and extends by being bent downwardly of the tub 2000, and a suspension (not shown) connected to the rear support and equipped with a spring and a damper. In this case, a rear portion of the tub 2000 may be inclined at a predetermined angle inside the cabinet 1000.

The drum 3000 is disposed inside the tub 2000 to rotate. In this regard, driving means 4000 for rotating the drum 3000 may be disposed at the rear of the tub 2000. When the drum 3000 rotates and moves inside the tub 2000, vibration is transmitted to the tub 2000. Therefore, structures mounted on the tub 2000 also vibrate together. Problems caused by the vibration and solutions thereof will be described later.

In one example, the tub 2000 may include a water supply pipe 8000 when washing water is supplied into the tub 2000. The water supply pipe 8000 may be constructed to be in communication with the tub 2000 via a detergent box equipped in the cabinet 1000. This is to ensure that detergent used in a washing process may be supplied to the tub 2000 together when the washing water is supplied.

In addition, the tub 2000 may further include a drain pipe 7000 for draining the washing water stored therein to the outside. When the drainage starts, the washing water will be drained from a bottom of the tub and will flow out of the laundry treating apparatus 1 via the drain pipe 7000 by a drain pump (not shown).

In a case of the laundry treating apparatus 1 with a washing function, depending on the laundry, it is necessary to perform washing by increasing a temperature of the washing water within a range that does not cause permanent damage (e.g., shrinkage, distortion, loss of a waterproof function, and the like), so that a heating structure to increase the temperature of the washing water is required.

In addition, both the laundry treating apparatus 1, which has both washing and drying functions, and the laundry treating apparatus 1, which has only the drying function, need a heating structure for drying the laundry. Therefore, the laundry treating apparatus has the induction module 5000 that may be used for heating the washing water or drying.

The induction module 5000 is mounted on an outer circumferential surface of the tub 2000 and serves to heat a circumferential surface of the drum 3000 via a magnetic field generated by applying current to a coil 5150 around which a wire 5151 is wound.

The wire 5151 may be composed of a core wire and a coating surrounding the core wire. The core wire may be a single core wire. In one example, a plurality of core wires may be entangled to form one core wire. Therefore, it may be said that a thickness or a wire diameter of the wire 5151 is determined by thicknesses of the core wire and the coating.

A scheme in which the coil 5150 heats the drum 3000 will be described. An alternating current whose phase changes flows to the coil 5150 on an outer side of the circumferential surface of the drum 3000, and the coil 5150 forms a radial alternating magnetic field based on the Ampere's circuit law.

Such alternating magnetic field is concentrated toward the drum 3000 made of a conductor with high magnetic permeability. Here, the magnetic permeability refers to an extent to which a medium is magnetized with respect to a given magnetic field. At this time, an eddy current is formed on the drum 3000 based on the Faraday's law of induction. Such eddy current flows along the drum 3000 made of the conductor and is converted into Joule heat by a resistance of the drum 3000 itself. Accordingly, an inner wall of the drum 3000 is directly heated.

When the inner wall of the drum 3000 is directly heated, a temperature of air inside the drum 3000 and a temperature of the laundry in contact with the inner wall of the drum 3000 rise together. Accordingly, because direct heating of the laundry is possible, faster drying is achieved compared to a drier using only a hot air drying scheme or a low-temperature dehumidifying drying scheme, which is an indirect heating scheme.

In addition, in a case of the laundry treating apparatus 1 having the washing function, the washing water may be heated without having the separate heating wire and the flow channel, and the washing water may continuously come into contact with inner and outer walls of the drum 3000. Therefore, faster heating of the washing water may be achieved compared to a scheme in which the separate flow channel and the heating wire are formed below the tub and the washing water is heated using the separate flow channel and the heating wire.

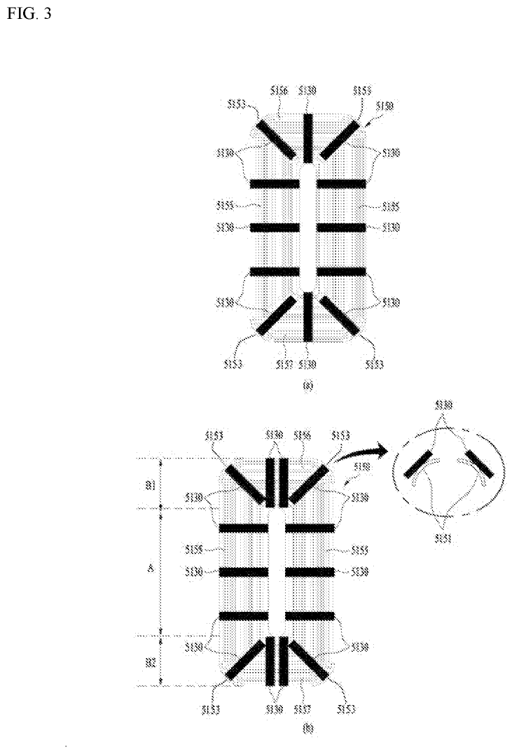

FIG. 3 is a top view showing an arrangement structure of a coil and permanent magnets.

Referring to FIG. 3, a top surface of the coil 5150 in which the wire 5151 is wound on an outer side of the outer circumferential surface of the tub 2000 is shown.

The coil 5150 may be formed in any shape such as a concentric circle, an ellipse, or a track shape on the outer circumferential surface of the tub 2000 as long as the wire 5151 is wound to form the coil. A degree of heating of the drum 3000 may vary depending on the wound shape.

Because, when a coil inner portion and a coil outer portion have different radii of curvature at a curved portion of the coil, there may be a problem in that an amount of magnetic field transmitted to a central portion of the drum 3000 and amounts of magnetic field transmitted to front and rear portions of the drum 3000 are significantly different from each other.

In other words, because an area of a portion of the coil located near the front and rear portions of the drum 3000 is narrow, an amount of magnetic field transmitted to a front portion of the circumferential surface of the drum 3000 is inevitably small, and because an area of a portion of the coil located at a central portion A is large, an amount of magnetic field transmitted to a central portion of the circumferential surface of the drum 3000 is inevitably relatively large. Therefore, it becomes difficult to uniformly heat the drum 3000.

Therefore, as shown in (a) in FIG. 3, the wire 5151 may be wound such that the coil 5150 has straight portions 5155, 5156, and 5157 and curved portions 5153. It is preferable that a radius of curvature of a portion of the wire 5151 forming the curved portion 5153 is uniform in the coil inner portion and the coil outer portion.

A relationship between the straight portions 5155, 5156, and 5157 and the curved portions 5153 will be described in more detail. The straight portions 5155, 5156, and 5157 may include horizontal straight portions 5156 and 5157 including a front straight portion 5156 disposed at a front portion of the outer circumferential surface of the tub 2000 and a rear straight portion 5157 disposed at a rear portion of the outer circumferential surface of the tub 2000, and vertical straight portions 5155 formed perpendicular to the horizontal straight portions 5156 and 5157. The curved portions 5153 are formed at points where the horizontal straight portions 5156 and 5157 meet the vertical straight portions 5155.

That is, the coil may be composed of the front straight portion 5156, the rear straight portion 5157, the vertical straight portions 5155 on both sides, and the four curved portions formed between the straight portions 5155, 5156, and 5157 and having an equal radius of curvature 5153.

According to the configuration described above, both ends B1 and B2 of the coil including a coil front end adjacent to the front portion of the tub 2000 and a coil rear end adjacent to the rear portion of the tub, and a coil central portion A located between both ends B1 and B2 of the coil may have a uniform horizontal width.

As a result, amounts of magnetic field radiated from both coil ends B1 and B2 to the front and rear portions of the circumferential surface of the drum 3000 and an amount of magnetic field radiated from the central portion A of the coil to the central portion of the circumferential surface of the drum 3000 are similar to each other.

Therefore, an effect of uniformly heating both the central portion of the circumferential surface of the drum 3000 and the front and rear portions thereof is derived.

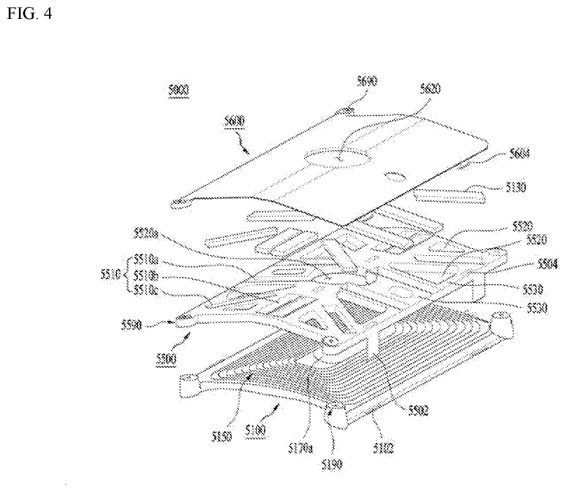

FIG. 4 is an exploded perspective view of an induction module.

An overall structure of the induction module 5000 will be described below with reference to FIG. 4.

In one example, the induction module 5000 of the present embodiment is composed of a base housing 5100 for accommodating the coil 5150 thereon, a permanent magnet housing 5500 for accommodating permanent magnets 5130 therein, and a cover housing 5600 for covering the permanent magnet housing 5500. That is, in the present embodiment, the cover of the above-described embodiment is separated into the permanent magnet housing 5500 and the cover housing 5600. In addition, the permanent magnets 5130 may be inserted into the permanent magnet housing 5500 downwardly, and the cover housing 5600 may be fastened to prevent the permanent magnets 5130 from being removed from the permanent magnet housing 5500.

Each component will be described in detail as follows.

First, the base housing 5100 will be described.

The base housing 5100 has a substantially quadrangular shape, preferably a rectangular shape, and the coil 5150 is accommodated on top of the base housing 5100. Preferably, a through portion 5170a is defined near a center of the base housing 5100.

Each fastening portion 5190 is disposed at each corner of the base housing 5100, and the fastening portion 5190 preferably protrudes outward from the corner. In addition, rings 5102 coupled with respective hooks 5502 of the permanent magnet housing 5500 are formed on edges of the base housing 5100. It is preferable that there are a total of four rings 5102, two on each of both long sides of the base housing 5100.

Because structures of other portions of the base housing 5100 may be substantially similar to those of the base housing of the above-described embodiment, description of the structures of other portions is omitted.

Next, the permanent magnet housing 5500 will be described.

The permanent magnet housing 5500 preferably has a shape substantially corresponding to that of the base housing 5100. For example, the permanent magnet housing 5500 preferably has the rectangular shape.

The permanent magnet housing 5500 has mounting portions 5510 in which the permanent magnets 5130 are installed. In addition, because the permanent magnet housing 5500 is preferably composed of one component, it is preferable that there is a connecting portion 5530 for connecting the multiple mounting portions 5510 to each other. It is preferable that the connecting portion 5530 has an open structure rather than a closed structure in a vertical direction, so that heat generated from the coil 5150 may be transferred. Therefore, it is preferable that through portions 5520 open in the vertical direction are defined in the connecting portion 5530.

The multiple mounting portions 5510 may be defined. It is preferable that multiple mounting portions 5510 are defined radially from vicinity of the center toward the edge of the base housing 5100. Because the mounting portion 5510 is a portion where the permanent magnet 5130 is seated, it is preferable that the mounting portion 5510 has a shape corresponding to that of the permanent magnet 5130, that is, a narrow rectangular shape.

Specifically, the mounting portions 5510 may include long side mounting portions 5510a, short side mounting portions 5510b, and corner mounting portions 5510c. Two long side mounting portions 5510a may be defined on both sides of vicinity of a center of each long side of the base housing 5100. Two short side mounting portions 5510b may be defined on both sides of vicinity of a center of each short side of the base housing 5100. Four corner mounting portions 5510c may be defined in a direction from the central portion to the edge of the base housing 5100.

The through portion 5520 may be defined to open a portion where the mounting portion 5510 is not defined, for example, a space between the mounting portion 5510 and a neighboring mounting portion 5510, in the vertical direction. That is, it is preferable that the through portion 5520 is defined to have a shape corresponding to a shape of the space between the mounting portion 5510 and the neighboring mounting portion. In addition, because the through portion 5520 may dissipate the heat generated from the coil 5150, the through portion 5520 preferably has an area as large as possible within a range capable of maintaining a strength of the permanent magnet housing 5500.

Specifically, it is preferable that a thickness of the mounting portion 5510 in which the permanent magnet 5130 is mounted is 2.0 t, and a thickness of the connecting portion 5530 for connecting the multiple mounting portions 5510 to each other is 1.5 t. The mounting portion 5510, as the portion in which the permanent magnet 5130 is seated, may be formed thicker than the connecting portion 5530 to maintain rigidity thereof. The connecting portion 5530 may be formed thinner than the mounting portion 5510 in order to support the permanent magnets 5130, and at the same time, maintain a constant distance from the base housing 5100 for accommodating the coil 5150 thereon.

When high-temperature heat is applied to the permanent magnets 5130, atoms migrate randomly and lose magnetism thereof, which may lead to durability degradation of the induction module 5000.

Therefore, a difference in the thickness between the mounting portion 5510 and the connecting portion 5530 may occur at a bottom surface of the permanent magnet housing 500 so as to prevent a temperature of the permanent magnets 5130 from rising due to the heat generated by the coil 5150.

In one example, each fastening portion 5590 is disposed at each corner of the permanent magnet housing 5500, and the fastening portion 5590 preferably protrudes outward from the corner.

The hooks 5502 extending downwards are formed on an edge of the permanent magnet housing 5500, and each hook 5502 is inserted into each ring 5102 of the base housing 5100.

In addition, grooves 5504 are defined at predetermined positions of an inner portion of the permanent magnet housing 5500, and each groove 5504 is coupled with each hook 5604 of the cover housing 5600.

Next, the cover housing 5600 will be described.

The cover housing 5600 preferably has a shape substantially corresponding to that of the permanent magnet housing 5500. For example, the cover housing 5600 preferably has the rectangular shape. A through portion 5620 may be defined at a center of the cover housing 5600, and a fan (not shown) may be mounted in the through portion 5620. Fastening portions 5690 are disposed at corners of the cover housing 5600, and a hole of the fastening portion 5690 is preferably a long hole. The hooks 5604 respectively coupled to the grooves 5504 of the permanent magnet housing 5500 are disposed on a lower portion of the cover housing 5600.

The permanent magnet housing 5500 will be described in more detail.

It is preferable that the mounting portion 5510 in which the permanent magnet 5130 is seated has an open top surface such that the permanent magnet 5130 is able to be inserted downwards. In this way, it is easy to insert the permanent magnet 5130 into the permanent magnet mounting portion 5510. It is preferable that the permanent magnet 5130 seated in the permanent magnet mounting portion 5510 is prevented from being removed because of the cover housing 5600 coupled thereto from the top.

The mounting portions 5510 will be described in detail.

As described above, it is preferable that the permanent magnet 5130 is inserted into the mounting portion 5510 downwards. Therefore, it is preferable that the mounting portion 5510 has an opening 5512a at the top surface thereof, and the permanent magnet 5130 is inserted into the opening 5512a. In addition, the mounting portion 5510 must have a space where the permanent magnet 5130 is fixed. Accordingly, the mounting portion 5510 has a barrier rib 5512b extending downwardly of the opening 5512a, and the permanent magnet 5130 is fixedly supported by the barrier rib 5512b. It is preferable that a cross-sectional shape of the barrier rib 5512b substantially corresponds to a shape of the permanent magnet 5130. In addition, a support 5512c for supporting the permanent magnet 5130 not to fall out is disposed at a lower front end of the barrier rib 5512b. Preferably, the support 5512c protrudes inwardly from the lower front end of the barrier rib 5512b.

In one example, as described above, the permanent magnet housing 5500 has the connecting portion 5530 for connecting the mounting portions 5510 to each other. The connecting portion 5530 is positioned between the mounting portions 5510 to connect the mounting portions 5510 to each other. The connecting portion 5530 may connect predetermined positions, for example, upper portions or lower portions of the barrier ribs 5510b of the mounting portions 5510 to each other.

However, in order to efficiently discharge the heat generated from the coil 5150, it is preferable that the connecting portion 5530 connects the upper portions of the mounting portions 5510 to each other. This is because, in such configuration, the space between the mounting portion 5510 and the neighboring mounting portion 5510 becomes a convection space for dissipating the heat from the coil 5150. That is, the heat generated from the coil 5150 may be dissipated upwardly of the permanent magnet housing 5500 via the convection space and the through portion 5520.

That is, the cover housing 5600 is fastened to the base housing 5100 from above while defining a predetermined space such that the heat generated from the coil may be transferred.

Specifically, the cover housing 5600 may have the through portion 5620 that vertically extends through the cover housing 5600 such that the heat may be dissipated, and the cover housing 5600 may form a cross-section inclined upwards toward the through portion 5620, so that the heat generated from the coil may be transferred along the inclined cross-section and may be discharged through the through portion 5620.

The space in which the heat may be transferred may be defined by the base housing 5100 and the cover housing 5600, and the heat generated from the coil accommodated in the base housing 5100 may form an ascending airflow, and may be dissipated to the outside of the induction module 5000 through the through portion 5620 by being transferred along an upwardly inclined inner surface of the cover housing 5600.

As described above, in order to induce the dissipation of the heat generated from the coil by the natural convection, preferably, the through portion 5620 may be defined at an uppermost end of the induction module 5000 and may be defined at the center of the cover housing 5600.

The uppermost end may refer to a place where a vertical level difference between the cover housing 5600 and the base housing 5100 is the greatest, and the central portion of the cover housing 5600 may be differently defined based on the shape of the cover housing 5600.

In the present embodiment, the cover housing 5600 may be formed in the rectangular shape composed of two long sides and two short sides, the through portion 5620 may be defined at the center of the cover housing 5600, and the cover housing 5600 may form the cross-section inclined upwards from each of the two long sides toward the through portion 5620.

According to another embodiment of the present disclosure, the cover housing 5620 may be formed in a shape of being bent based on a virtual line parallel to the two long sides and crossing a midpoint of the cover housing 5600, and a degree to which the cover housing 5600 is bent may correspond to a shape of the outer circumferential surface of the drum.

Therefore, the base housing 5100 and the cover housing 5600 may be bent to correspond to the outer circumferential surface of the drum, and the heat generated from the coil may be transferred along the bent surface of the cover housing 5600 and be dissipated through the through portion 5620.

Specifically, it is preferable that the permanent magnet housing 5500 disposed between the base housing 5100 and the cover housing 5600 is also bent to correspond to the outer circumferential surface of the drum, the base housing 5100, the permanent magnet housing 5500, and the cover housing 5600 are bent with the same curvature, and the curvature matches a curvature formed by the outer circumferential surface of the drum.

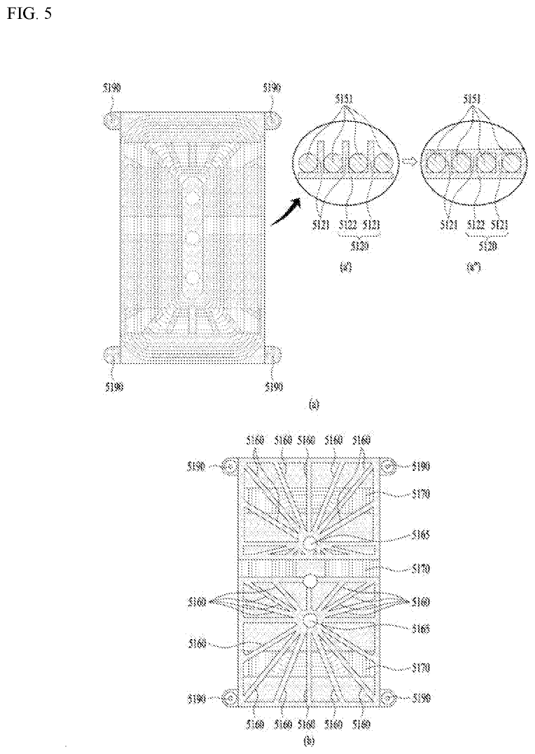

FIG. 5 shows a top view and a bottom view of a base housing.

Referring to FIG. 5, the base housing 5100 will be described in more detail.

As shown in (a′) and (a″) in FIG. 5, the base housing 5100 may form a coil slot 5120 having a width smaller than the wire diameter of the wire 5151 such that the wire 5151 of the coil 5150 is forcibly fitted, and the width of the coil slot 5120 may be 93% to 97% of the wire diameter of the wire 5151.

When the wire 5151 is forcibly fitted into the coil slot 5120, even when the tub 2000 vibrates, the wire 5151 is fixed inside the coil slot 5120, so that the coil 5150 does not move.

Therefore, the coil 5150 may not deviate from the coil slot 5120, and because the movement of the coil 5150 itself is suppressed, noise that may occur caused by a gap may be prevented.

Furthermore, the coil slot 5120 may be formed by a plurality of fixing ribs 5121 protruding upward from the base housing 5100, and a vertical dimension of the fixing ribs 5121 may be greater than the wire diameter of the coil 5150.

The vertical dimension of the fixing ribs 5121 should be greater than the wire diameter of the coil 5150 so that both surfaces of the coil 5150 may be sufficiently in contact with and be supported by the inner walls of the fixing ribs 5121. Such characteristic is also related to a melting process of upper ends of the fixing ribs 5121 to be described later.

The above characteristic may prevent short circuits by allowing adjacent turns of the wire 5151 to be separated from each other and fixed, and may reduce a production cost because there may be no need to coat the wire 5151 with a separate insulating film or a thickness of the insulating film may be minimized.

In addition, the upper ends of the fixing ribs 5121 may be melted after the wire 5151 is inserted thereinto so as to cover a top of the coil 5150. That is, the upper ends of the fixing ribs 5121 may be melted.

In this regard, the vertical dimension of the fixing ribs 5121 is preferably 1 to 1.5 times the wire diameter of the wire 5151 so as to cover the top of the coil 5150.

Specifically, referring to (a″) in FIG. 5, after the wire is forcibly fitted, top surfaces of the fixing ribs 5121 may be melted while being pressed. Then, as shown in (a″) in FIG. 5, the melted portion of each fixing rib 5121 may spread to both sides to cover the top of turns of the wire 5151 on both sides. In this regard, it is preferable that each adjacent two fixing ribs 5121 with each turn of the wire 5151 interposed therebetween are melted such that the top of each turn of the wire 5151 is completely shielded in the coil slot 5120 or melted to define a gap narrower than the wire diameter of the wire 5151 at the top of each turn of the wire 5151.

In another embodiment, the fixing rib 5121 of the coil slot 5120 may be melted to cover only a turn of the wire 5151 on one side instead of the turns of the wire 5151 on both sides. In this case, each of all the fixing ribs 5121 should be melted so as to cover only a turn of the wire 5151 disposed on an inner side among the turns of the wire 5151 adjacent thereto, or cover only a turn of the wire 5151 disposed on an outer side.

The reason for melting the upper ends of the fixing ribs 5121 in addition to fixing the coil 5150 in the coil slot 5120 by the force fitting is to physically block a path along which the wire 5151 may escape, to prevent noise caused by vibration of the tub 2000 by preventing the movement of the wire 5151, and to improve durability by eliminating the gap between the parts.

The coil slot 5120 may further include a slot base 5122 on which the coil 5150 is seated at a location between the fixing ribs 5121 and in contact with bottom surfaces of the fixing ribs 5121.

As shown in (a″) in FIG. 5, the slot base 5122 has a bottom surface for shielding the coil 5050 and serves to press and fix the coil 5150 together with the melted fixing ribs 5121.

However, portions of the slot base 5122 may be open. In this regard, the open structures defined in the slot base 5122 may be referred to as through holes or through portions 5170.

Hereinabove, the description has been made on the premise that the coil 5150 is disposed on the top surface of the base housing 5100, but the fixing ribs 5151 may protrude downwardly of the base housing 5100 such that the coil 5150 is disposed on a bottom surface of the base housing 5100. In this case, even when the separate through portions are not defined in the slot base 5122, the space defined by the melted fixing ribs 5121 serves as the through portion.

(b) in FIG. 5 is a view showing the bottom surface of the base housing 5100. As shown in the drawing, the base housing 5100 may have the through portions 5170 defined therethrough, and the through portions 5170 may have an open structure such that the coil 5150 may face the outer circumferential surface of the tub 2000, and may be defined along the wound shape of the wire 5151.

When the through portions 5170 are defined along the wound shape of the wire 5151, a heating efficiency may be increased as the magnetic field is smoothly radiated from the wire 5151 toward the drum 3000 and the overheated coil 5150 may be quickly cooled as air may flow along the open surface.

In addition, referring to (b) in FIG. 5, base support bars 5160 formed on the bottom surface of the base housing 5100 to intersect the through portions are disclosed, and the base housing 5100 may further include the base support bars 5160.

The base support bars 5160 may be radially formed around fixed points 5165 on both sides of the central portion A of the base housing 5100 so as to enhance an adhesion between the outer circumferential surface of the tub 2000 and the base housing 5100.

When the base fastening portions 5190 disposed at both sides of the base housing 5100 are fixed to tub fastening portions 2100 disposed on the tub outer circumferential surface, because the outer circumferential surface of the tub 2000 is pressurized by the base support bars 5160, stronger support may be achieved compared to a case in which an entire bottom surface of the base housing 5100 is in contact with the outer circumferential surface of the tub 2000. Accordingly, even when the tub 2000 vibrates, the base housing 5100 does not easily move or escape from the outer circumferential surface of the tub 2000.

Furthermore, in order to improve a fastening force between the base housing 5100 and the outer circumferential surface of the tub 2000, the base housing 5100 may form a curved surface corresponding to the outer circumferential surface of the tub 2000.

On the top surface of the base housing 5100 on which the wire 5151 is wound, all the curved portions of the fixing ribs 5121 may have an equal radius of curvature to correspond to the above-described characteristics that the coil curved portions 5153 have the equal radius of curvature.

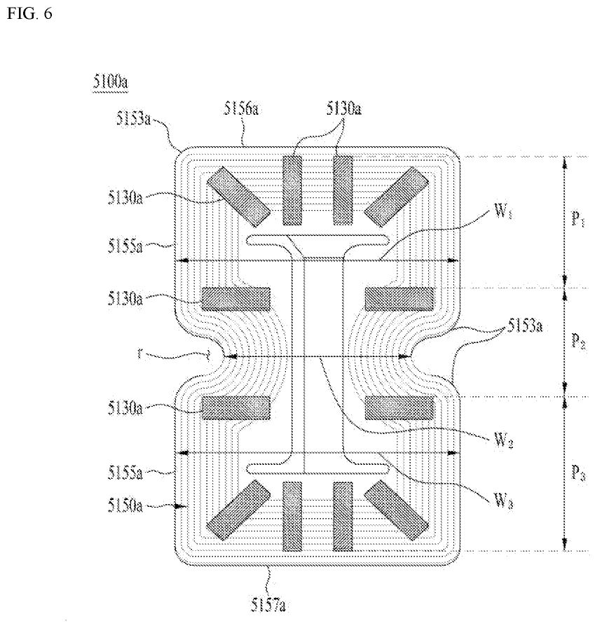

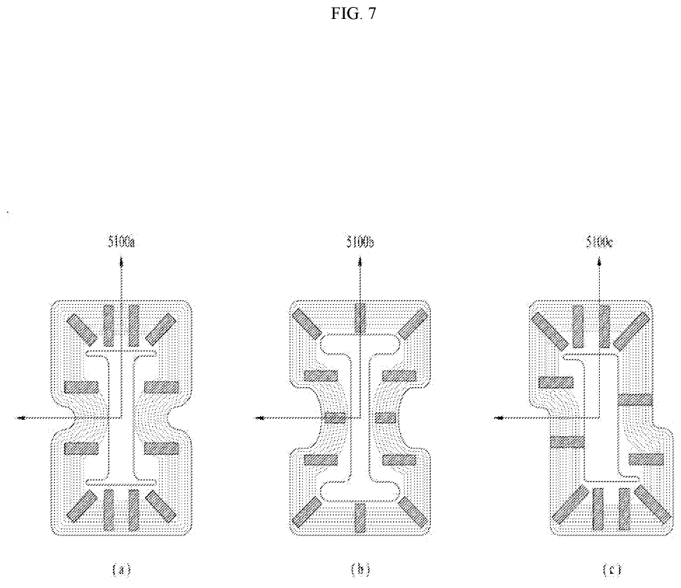

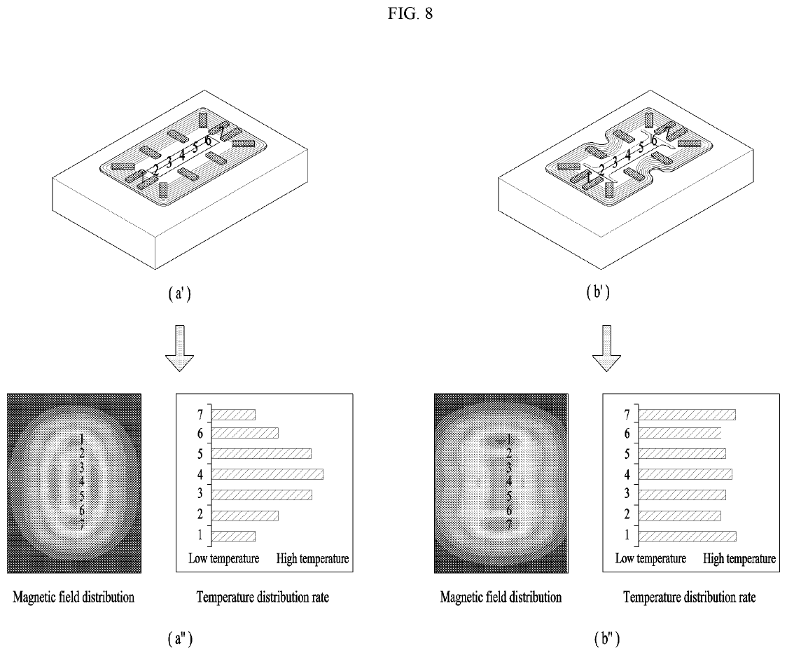

FIG. 6 is a top view showing an arrangement structure of a coil and permanent magnets according to one embodiment of the present disclosure, FIG. 7 is a top view showing arrangement structures of a coil and permanent magnets according to various embodiments of the present disclosure, and FIG. 8 is a view showing a temperature distribution rate based on a coil shape.

[symbol]

Prior to describing an arrangement structure of the coil and the permanent magnets according to one embodiment of the present disclosure with reference to FIGS. 6 to 8, while the coil of the induction module described above is formed in the track shape having the two long sides and the two short sides, a coil described in the present drawing is formed in a shape for increasing coil areas at both ends thereof.

Therefore, the basic structure of the induction module described above may be equally applied to an embodiment to be described below.

A base housing 5100a of the present embodiment may include a first area P1, which is a portion located adjacent to the front portion of the drum 3000, a third area P3, which is a portion located adjacent to the rear portion of the drum 3000, and a second area P2, which is a portion located between the first area P1 and the third area P3.

A criterion for dividing the first area P1, the second area P2, and the third area P3 may be relatively set. As an example, the areas may be distinguished from each other based on the number of permanent magnets 5130a disposed in each area.

More specifically, the permanent magnets 5130a act as a blocking member to prevent heating of other nearby components besides the drum 3000, and to concentrate a magnetic field generated by a coil 5150a in a direction of the drum 3000 to improve the heating efficiency.

As disclosed in the present embodiment, the permanent magnets 5130a may be formed as bar magnets. It is preferable that the permanent magnets 5130a are positioned on the coil 5150a, but are disposed perpendicular to a longitudinal direction of the coil 5150a. This is to cover the coil inner portion and the coil outer portion at the same time.

The permanent magnets 5130a may be a plurality of bar magnets having the same size, and the plurality of permanent magnets 5130a may be spaced apart from each other along the longitudinal direction of the coil 5150a.

This is because, when the permanent magnets 5130a are placed only at a specific location, an amount of magnetic field radiated to the drum 3000 varies for each portion of the circumferential surface of the drum 3000, making it difficult to perform the uniform heating. Therefore, in order to uniformly guide the magnetic field generated by the coil 5150a toward the drum 3000, it is preferable that the plurality of permanent magnets are spaced apart from each other along a circumference of the coil.

Furthermore, the number of permanent magnets 5130a disposed in the first area P1 or the third area P3 may be equal to or greater than the number of permanent magnets disposed in the second area P2.

In the second area P2, the magnetic field is radiated to extend to left and right sides of the coil 5150a. In this case, because a width of the drum 3000 is much greater than that of the second area P2, the uniform heating may be achieved in a width direction of the drum 3000 without arranging a large number of permanent magnets.

On the other hand, in the first area P1 and the third area P3, the magnetic field is radiated to extend to the left and right sides of the coil 5150a, as well as to the front portion of the drum 3000 in the first area P1 and to the rear portion of the drum 3000 in the third area P1.

In addition, a density of the coil is relatively small in the first area P1 and the third area P3. In other words, due to a round shape of the corner, the density of the coil is inevitably reduced at both ends of the coil. This is because it is impossible to form the coil vertically in theory at the corner.

Accordingly, it is preferable that the number of permanent magnets disposed in the first area P1 or the third area P3 is equal to or greater than the number of permanent magnets disposed in the second area P2.

As another example of the criterion for dividing the first area P1, the second area P2, and the third area P3 from each other, the first area P1 and the third area P3 may be distinguished from the second area P2 by a relative difference in a coil area. Briefly, a coil area of the first area P1 or the third area P3 may be greater than a coil area of the second area P2, which will be described in detail later.

Therefore, as described above, in order to make the coil area of the first area P1 and the third area P3 greater than the coil area of the second area P2, the smallest width w1 or w3 of the first area P1 or the third area P3 are greater than the smallest width w2 of the second area P2, so that the wire may be wound on the base housing 5100a such that the areas of the coil have different widths.

More specifically, the first area P1 and the third area P3 may be symmetric with each other with respect to the second area P2. That is, the smallest width w1 of the first area and the smallest width w3 of the third area may have the same length.

In addition, recessed areas r are defined in the second area P2, so that, as described above, the coil area of the second area P2 may be smaller than that of the first area P1 or the third area P3.

Furthermore, the base housing 5100a may be formed in a shape corresponding to the shape of the coil in order to satisfy the above-described area condition of the coil.

The base housing 5100a may be fixed to the tub 2000, so that the induction module may be spaced apart from the drum at a predetermined distance. Front and rear ends of the base housing 5100a may be disposed at positions respectively spaced apart from front and rear ends of the tub 2000 by a predetermined distance.

Because, as described above, in the first area P1 and the third area P3, which are distinguished as the areas adjacent to the front portion and the rear portion of the drum, respectively, the magnetic field is radiated along a rotational direction of the drum, as well as to the front and rear portions of the drum along a longitudinal direction of the drum perpendicular to the rotational direction of the drum.

That is, because the front and rear ends of the base housing 5100a are spaced apart from the front and rear ends of the tub by the predetermined distance, respectively, the magnetic field may be prevented from being unintentionally transmitted to other components disposed inside the laundry treating apparatus.

In one example, as described above, the induction module may include the cover housing 5600 fastened to the base housing 5100a from the top and having the through portion 5620 through which the heat generated from the coil is dissipated, and the permanent magnet housing 5500 disposed between the base housing 5100a and the cover housing 5600 and having the mounting portions 5510 in which the permanent magnets are accommodated, which is as described above.

In one example, the shapes of the base housing, the permanent magnet housing, and the cover housing may be changed to correspond to the coil shape of the present embodiment.

In one example, in the coil 5150a, the wire may be wound on the base housing so as to have straight portions and curved portions.

More specifically, portions of the coil wound in the first area P1 and the third area P3 may have respective straight portions 5156a and 5157a and curved portions 5153a. In this case, it is preferable that a radius of curvature of a portion of the wire forming the curved portion 5153a is uniform in the coil inner portion and the coil outer portion.

Because, when the radius of curvature of the curved portions 5153a varies in the coil inner portion and the coil outer portion, a difference may occur between the amount of the magnetic field transmitted to the center of the drum and the amount of the magnetic field transmitted to the front and rear portions of the drum.

Similarly, it is preferable for the uniform magnetic field transmission that a curvature radius of the wire in a curved portion formed in the recessed area 5130a of the second area P2 is also equal for the coil inner portion and the coil outer portion.

In one example, the base housing 5100a may be formed by being curved in a shape corresponding to that of the outer circumferential surface of the drum, and the coil 5150a may be wound along the curvature of the base housing. In this case, a magnetic flux density of the magnetic field directed to the drum 3000 may be further increased.

In addition, the base housing 5100a may include the coil slot 5120 narrower than the wire diameter of the wire such that the coil is forcibly fitted thereinto. Accordingly, even when the coil 5150a is wound along the curvature of the base housing, the coil 5150a may be prevented from being removed from the base housing due to the vibration of the drum.

Furthermore, the coil 5150a may have a vertical length corresponding to the longitudinal direction of the drum greater than a horizontal length corresponding to the width direction of the drum. This prevents the magnetic field from being radiated in an excessively wide range in a circumferential direction of the drum 3000 so as not to heat the components other than the drum 3000, and allows an arrangement space for a spring or other components that may be disposed on the outer circumferential surface of the tub 2000 to be secured.

(a) to (c) in FIG. 7 are views showing various embodiments satisfying the shape condition of the coil described in the present embodiment described above.

Referring to FIG. 8, (a) in FIG. 8 is a view showing magnetic field distribution and temperature distribution when the coil is formed in the track shape in FIG. 3, and (b) in FIG. 8 is a view showing magnetic field distribution and temperature distribution when the coil is formed in the shape in FIG. 6.

In (a′) and (b′) in FIG. 8, ‘1’ to ‘7’ indicate points where the drum is heated along the front to rear portions of the drum distinguished along the longitudinal direction of the drum. Therefore, ‘1’ represents the front portion of the outer circumferential surface of the drum, ‘7’ represents the rear portion of the outer circumferential surface of the drum, and ‘2’ to ‘6’ represent sections between the front and rear portions.

In addition, horizontal axes of the graphs in (a″) and (b″) in FIG. 8 represent relative temperature distribution. A left side of the horizontal axis of the graph means a relatively low temperature, and a right side of the horizontal axis of the graph means a relatively high temperature.

In addition, when the sections divided into ‘1’ to ‘7’ correspond to the first area to third area described above, the first area P1 may include the sections ‘1’ and ‘2’, the second area P2 may include the sections ‘3’ to ‘5’, and the third area P3 may include the sections ‘6’ and ‘7’.

Referring to (a″) in FIG. 8, in the coil structure of the induction module in the track shape, the magnetic fields of similar amounts are linked on portions of the circumferential surface of the drum located in the sections ‘3’ to ‘5’, which are central portion in the longitudinal direction of the drum, and in the sections ‘1’ and ‘7’, which are outer portions. Therefore, it may be seen that temperature superposition occurs in the sections ‘3 to 5’ as the drum rotates, and the drum is locally heated more in the sections ‘3’ to ‘5’.

Unlike the above, looking at the coil shape in (b′) in FIG. 8, the amount of the magnetic field linking in the sections ‘3’ to ‘5’, which are the central portion in the longitudinal direction of the drum, is smaller than the amount of the magnetic field linking in the sections ‘1’ and ‘7’, which are relatively outer portions. Therefore, the drum may be heated uniformly in an entire area with the temperature superposition as the drum rotates.

That is, as described above, as the area of the portions of the coil wound in the first area P1 and the third area P3 is greater than the area of the portion of the coil wound in the second area P2, the amount of magnetic field linking in the first area P1 and the third area P3 is greater than the amount of magnetic field linking in the second area P2. Therefore, the temperature may be prevented from rising locally in the second area P2 as the drum rotates, and the drum may be heated uniformly in the entire area.

Although various embodiments of the present disclosure have been described in detail above, those with ordinary skill in the technical field to which the present disclosure belongs will understand that various modifications are possible with respect to the above-described embodiments without departing from the scope of the present disclosure. Therefore, the scope of rights of the present disclosure should not be limited to the described embodiments and should be defined by the claims to be described later as well as equivalents thereof.

What is claimed is:

1. A laundry treating apparatus comprising:
a cabinet;
a drum disposed inside the cabinet and made of a metal material so as to accommodate laundry therein; and
an induction module spaced apart from a circumferential surface of the drum and heating the circumferential surface of the drum via a magnetic field generated as a current is applied to a coil composed of a wound wire,
wherein the induction module includes a base housing for accommodating the coil thereon,
wherein the coil includes a first area positioned adjacent to a front portion of the drum, a third area positioned adjacent to a rear portion of the drum, and a second area positioned between the first area and the third area,
wherein the smallest width of the first area or the third area is greater than the smallest width of the second area, and the wire is wound on the base housing such that the coil has different widths in the first area or the third area and the second area.

2. The laundry treating apparatus of claim 1, wherein a coil area in the first area or the third area is greater than a coil area in the second area.

3. The laundry treating apparatus of claim 1, further comprising a tub for accommodating the drum therein,
wherein the base housing is fixed to the tub.

4. The laundry treating apparatus of claim 3, wherein front and rear ends of the base housing are spaced apart from front and rear ends of the tub by a predetermined distance, respectively.

5. The laundry treating apparatus of claim 3, wherein the induction module further includes a cover housing coupled to the base housing from above and having a through portion defined therein for dissipating heat generated from the coil.

6. The laundry treating apparatus of claim 5, wherein the induction module further includes a permanent magnet located on the coil and concentrating the magnetic field generated by the coil in a direction toward the drum.

7. The laundry treating apparatus of claim 6, wherein the permanent magnet is disposed perpendicular to a longitudinal direction of the coil.

8. The laundry treating apparatus of claim 6, wherein the permanent magnet includes a plurality of permanent magnets arranged to be spaced apart from each other along a longitudinal direction of the coil.

9. The laundry treating apparatus of claim 8, wherein the number of permanent magnets arranged in the first area or the third area is equal to or greater than the number of permanent magnets arranged in the second area.

10. The laundry treating apparatus of claim 6, wherein the induction module further includes a permanent magnet housing disposed between the base housing and the cover housing and having mounting portions for respectively accommodating the permanent magnets therein.

11. The laundry treating apparatus of claim 1, wherein the wire is wound on the base housing such that the coil has straight portions and curved portions, wherein a radius of curvature of a portion of the wire forming the curved portion is uniform in a coil inner portion and a coil outer portion.

12. The laundry treating apparatus of claim 1, wherein the base housing is formed by being curved in a shape corresponding to a shape of an outer circumferential surface of the drum, and the coil is wound along the curvature of the base housing.

13. The laundry treating apparatus of claim 12, wherein the base housing further includes a coil slot narrower than a diameter of the wire such that the wire is forcibly fitted thereinto.

14. The laundry treating apparatus of claim 1, wherein a vertical length of the coil corresponding to a longitudinal direction of the drum is greater than a horizontal length of the coil corresponding to a width direction of the drum.
